(19) United States
(12) Patent Application Publication
(10) Pub. No.: US 2026/0304542 A1
(43) Pub. Date: Oct. 1, 2026

(54) METHOD AND APPARATUS FOR INTEGRATED SENSING AND COMMUNICATION IN WIRELESS COMMUNICATION SYSTEM

(71) Applicant: Samsung Electronics Co., Ltd., Suwon-si, Gyeonggi-do (KR)

(72) Inventors: Weiwei WANG, Beijing (CN); Chen QIAN, Beijing (CN); Hong WANG, Beijing (CN); Lixiang XU, Beijing (CN)

(21) Appl. No.: 19/475,947

(22) PCT Filed: Dec. 27, 2023
(86) PCT No.: PCT/KR2023/021639

§ 371 Date: Oct. 16, 2025

(30) Foreign Application Priority Data
May 15, 2023 (CN) 202310545532.2

(51) Int. Cl. H04W 76/27; H04L 5/00

(52) U.S. Cl. CPC H04W 76/27; H04L 5/0023

(57) ABSTRACT

The present disclosure relates to a 5G communication system or a 6G communication system for supporting higher data rates beyond a 4G communication system such as long term evolution (LTE). The present disclosure provides a method performed by a first node or a first or second network node, wherein the method performed by the first node compromises: receiving a first message from the first network node, and determining whether to enter a connected state based on the first message, wherein the first message includes indication information of a state related to sensing, and the indication information of the state related to sensing includes at least one of: indication information of a state for performing transfer of a sensing signal, and indication of a state for performing reporting of a sensing result, and wherein the first node is in a non-connected state.

### TECHNICAL FIELD

The present disclosure relates to the field of communication. More specifically, the disclosure provides a method performed by a first node, a method performed by a first network node, a method performed by a second network node, a first node, a first network node, and a second network node for integrated sensing and communication (ISAC) in wireless (or, mobile) communication system.

### BACKGROUND ART

Considering the development of wireless communication from generation to generation, the technologies have been developed mainly for services targeting humans, such as voice calls, multimedia services, and data services. Following the commercialization of 5G (5 th generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th generation) era, there have been ongoing efforts to develop improved 6G communication systems. For these reasons, 6G communication systems are referred to as beyond-5G systems.

6G communication systems, which are expected to be commercialized around 2030, will have a peak data rate of tera (1,000 giga)-level bit per second (bps) and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz (THz) band (for example, 95 gigahertz (GHz) to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, Radio Frequency (RF) elements, antennas, novel waveforms having a better coverage than Orthogonal Frequency Division Multiplexing (OFDM), beamforming and massive Multiple-input Multiple-Output (MIMO), Full Dimensional MIMO (FD-MIMO), array antennas, and multiantenna transmission technologies such as large-scale antennas. In addition, there has been ongoing discussion on new technologies for improving the coverage of terahertz-band signals, such as metamaterial-based lenses and antennas, Orbital Angular Momentum (OAM), and Reconfigurable Intelligent Surface (RIS).

Moreover, in order to improve the spectral efficiency and the overall network performances, the following technologies have been developed for 6G communication systems: a full-duplex technology for enabling an uplink transmission and a downlink transmission to simultaneously use the same frequency resource at the same time; a network technology for utilizing satellites, High-Altitude Platform Stations (HAPS), and the like in an integrated manner; an improved network structure for supporting mobile base stations and the like and enabling network operation optimization and automation and the like; a dynamic spectrum sharing technology via collision avoidance based on a prediction of spectrum usage; an use of Artificial Intelligence (AI) in wireless communication for improvement of overall network operation by utilizing AI from a designing phase for developing 6G and internalizing end-to-end AI support functions; and a next-generation distributed computing technology for overcoming the limit of UE computing ability through reachable super-high-performance communication and computing resources (such as Mobile Edge Computing (MEC), clouds, and the like) over the network. In addition, through designing new protocols to be used in 6G communication systems, developing mechanisms for implementing a hardware-based security environment and safe use of data, and developing technologies for maintaining privacy, attempts to strengthen the connectivity between devices, optimize the network, promote softwarization of network entities, and increase the openness of wireless communications are continuing.

It is expected that research and development of 6G communication systems in hyper-connectivity, including person to machine (P2M) as well as machine to machine (M2M), will allow the next hyper-connected experience. Particularly, it is expected that services such as truly immersive extended Reality (XR), high-fidelity mobile hologram, and digital replica could be provided through 6G communication systems.

In addition, services such as remote surgery for security and reliability enhancement, industrial automation, and emergency response will be provided through the 6G communication system such that the technologies could be applied in various fields such as industry, medical care, automobiles, and home appliances.

### DISCLOSURE OF INVENTION

### Technical Problem

Wireless communication is one of the most successful innovations in modern history. Recently, a number of subscribers of wireless communication services has exceeded 5 billion, and it continues growing rapidly. With the increasing popularity of smart phones and other mobile data devices (such as tablet computers, notebook computers, netbooks, e-book readers and machine-type devices) in consumers and enterprises, a demand for wireless data services is growing rapidly. In order to meet rapid growth of mobile data services and support new applications and deployments, it is very important to improve efficiency and coverage of wireless interfaces.

### Solution to Problem

According to an aspect of the present disclosure, there is provided a method performed by a first node, comprising: receiving a first message from a first network node, and determining whether to enter a connected state based on the first message; wherein the first message includes indication information of a state related to sensing, and the indication information of the state related to sensing includes at least one of: indication information of a state for performing transfer of a sensing signal, and indication information of a state for performing reporting of a sensing result; and wherein the first node is in a non-connected state.

According to the method performed by the first node provided by the present disclosure, wherein the first message is a paging message or a system message.

According to the method performed by the first node provided by the present disclosure, wherein the first message includes at least one of: first state indication information used for indicating state information of the first node when performing the transfer of a sensing signal; first node indication information used for indicating whether the first node needs to perform the transfer of a sensing signal; first sensing signal related information used for indicating configuration information required for the first node to perform the transfer of a sensing signal; and first report indication information used for indicating information for the first node to report the sensing result.

According to the method performed by the first node provided by the present disclosure, wherein the method further comprises: receiving a second message for indicating to the first node to receive the first message and/or information of the state related to sensing; the indication information of the state related to sensing is used for indicating information in the information of the state related to sensing.

According to the method performed by the first node provided by the present disclosure, wherein the second message includes at least one of: second state indication information used for indicating a state of the first node when performing the transfer of a sensing signal; second node indication information used for indicating whether the first node needs to perform the transfer of a sensing signal; second sensing signal related information used for indicating configuration information required for the first node to perform the transfer of a sensing signal; second report indication information used for indicating information for the first node to report the sensing result; and configuration information associated with acquiring the first message.

According to the method performed by the first node provided by the present disclosure, wherein the first state indication information or the second state indication information includes at least one of: connected state indication information used for indicating that the first node needs to enter a connected state; time indication information used for indicating time required to wait by the first node before entering the connected state; state trigger indication information used for indicating a condition required to be met for the first node to enter the connected state.

According to the method performed by the first node provided by the present disclosure, wherein the first node indication information or the second node indication information includes at least one of: identification information for a node, used for indicating a node for which the transfer of a sensing signal needs to be performed; identification information for a node group, used for indicating a node group for which the transfer of a sensing signal needs to be performed; identification information for an area, used for indicating an area for which the transfer of a sensing signal needs to be performed; identification information for a service, used for indicating a sensing service used by a node for which the transfer of a sensing signal needs to be performed; identification information for a sensing signal or type indication information for a sensing signal, used for indicating a triggered sensing signal; and state indication information used for indicating state information when the transfer of a sensing signal is performed.

According to the method performed by the first node provided by the present disclosure, wherein the first sensing signal related information or the second sensing signal related information includes at least one of: identification information for configuration, used for indicating a set of configuration information related to the sensing signal; valid time indication information used for indicating the first node to perform the transfer of a sensing signal within a time range indicated by the valid time indication information; sensing type indication information used for indicating a type of the transfer of a sensing signal; receiving and transmitting indication information used for indicating a manner in which the first node performs the transfer of a sensing signal; sensing enable indication information used for indicating whether the first node needs to perform the transfer of a sensing signal; synchronization indication information used for indicating whether the first node needs to perform synchronization when performing the transfer of a sensing signal; configuration information of a sensing signal, used for indicating resource configuration information of the sensing signal; state indication information used for indicating state information when the transfer of a sensing signal is performed.

According to the method performed by the first node provided by the present disclosure, wherein the sensing type indication information includes at least one of: sensing signals being transmitted and received by the first network node; sensing signals being transmitted by the first network node and received by the first node; sensing signals being transmitted by the first network node and received by a second network node; sensing signals being transmitted and received by the first node; sensing signals being transmitted by the first node and received by the first network node; and sensing signals being transmitted by the first node and received by a second node.

According to the method performed by the first node provided by the present disclosure, wherein the sensing enable indication information includes at least one of: resource configuration indication information used for indicating one or more configuration information of resources used for performing the transfer of a sensing signal; sequence indication information used for indicating information of a sequence used for performing the transfer of a sensing signal; time domain resource information used for indicating a configuration of resources on time domain for performing the transfer of a sensing signal; frequency domain resource information used for indicating a configuration of resources on frequency domain for performing the transfer of a sensing signal; and spatial domain resource information used for indicating a configuration of resources on spatial domain for performing the transfer of a sensing signal.

According to the method performed by the first node provided by the present disclosure, wherein the first report indication information or the second report indication information includes at least one of: trigger time indication information used for indicating a time length required to be experienced by the first node before performing the reporting of the sensing result; trigger condition indication information used for indicating a condition required to be met for the first node to perform the reporting of sensing result; and delayed connection indication information used for indicating the first node to delay entering the connected state.

According to the method performed by the first node provided by the present disclosure, wherein the time length indicated by the trigger time indication information corresponds to a timer length of a timer triggered by the first node, and a condition for starting the timer include at least one of: the first message being received; a sensing signal being received for the first time; a sensing signal being transmitted for the first time; and the transfer of a sensing signal being started.

According to the method performed by the first node provided by the present disclosure, the trigger condition indication information includes at least one of: threshold information for a measurement result of a sensing signal, threshold information for a number of times for receiving a sensing signal, threshold information for a number of times for transmitting a sensing signal, threshold information for a resolution of a sensing signal, and threshold information for an accuracy of a sensing signal; and sensing report indication information used for indicating configuration information of a sensing signal for which reporting of a sensing result needs to be performed.

According to the method performed by the first node provided by the present disclosure, the trigger condition indication information includes at least one of: threshold information for a measurement result of a sensing signal, threshold information for a number of times for receiving a sensing signal, threshold information for a number of times for transmitting a sensing signal, threshold information for a resolution of a sensing signal, and threshold information for an accuracy of a sensing signal; and sensing report indication information used for indicating configuration information of a sensing signal for which reporting of a sensing result needs to be performed.

According to the method performed by the first node provided by the present disclosure, wherein the sensing report indication information includes at least one of: position information for sensing result reporting, used for indicating a position at which the first node is when reporting the sensing result; position information for reception and transmission of a sensing signal, used for indicating a position for reception and transmission of a sensing signal to which the sensing result reported by the first node is referring; sensing service indication information used for indicating a sensing service to which the sensing result reported by the first node belongs; and reporting user indication information used for indicating a user who reports the sensing result, and this information may be identification information of the user.

According to the method performed by the first node provided by the present disclosure, wherein the configuration information associated with acquiring the first message includes at least one of: signaling decoding information used for indicating information required to acquire the first message, and related resource configuration information used for indicating a resource configuration in time domain or frequency domain or spatial domain for receiving the first message.

According to the method performed by the first node provided by the present disclosure, wherein a mode for receiving the first message includes at least one of: acquiring resources for scheduling the first message through a physical channel; acquiring the first message through a paging message; and acquiring the first message through the physical channel.

According to the method performed by the first node provided by the present disclosure, wherein determining the state of the first node when performing the transfer of a sensing signal based on the first message includes at least one of: determining whether the first node needs to enter the connected state to perform the transfer of a sensing signal based on the first state indication information; determining a condition for the first node to enter the connected state to perform the transfer of a sensing signal based on the first state indication information, and determining whether to enter the connected state based on the condition.

According to the method performed by the first node provided by the present disclosure, wherein determining the transfer of a sensing signal based on the first message includes at least one of: determining that the first node performs the transfer of a sensing signal and storing a obtained sensing result based on the first node indication information matching the node information at the first node; determining a sensing signal to be transferred, based on the first sensing signal related information and the second sensing signal related information, performing the transfer of a sensing signal, and storing the obtained sensing result; and starting a process of connection setup or resume, based on the reporting condition indicated in the first report indication information being met.

According to the method performed by the first node provided by the present disclosure, wherein the method comprises: transmitting a first report message, wherein the first report message is used for providing a sensing result obtained by the first node.

According to the method performed by the first node provided by the present disclosure, wherein the obtained sensing result or the first report message includes at least one of: sensing signal indication information used for indicating a sensing signal to which the sensing result is referring, and sensing result indication information used for indicating a sensing result obtained by the first node.

According to the method performed by the first node provided by the present disclosure, wherein the sensing signal indication information includes at least one of: identification information for a third node, used for indicating a node to which the sensing signal is referring; identification information for a third node group, used for indicating a node group to which the sensing signal is referring; identification information of a third service, used for indicating a service to which the sensing signal is referring, and configuration information of a third sensing signal, used for indicating a configuration of the sensing signal.

According to the method performed by the first node provided by the present disclosure, wherein the sensing result indication information includes at least one of: a sensing resolution; a measurement result of a sensing signal; an accuracy of a sensing signal; a number of times for transmitting a sensing signal; and a number of times for receiving a sensing signal.

According to the method performed by the first node provided by the present disclosure, the method further comprises: receiving a first report request message, wherein the first report request message includes at least one of: first sensing result request indication information used for indicating the first node to report its stored sensing result; first sensing result report indication information used for indicating information of the sensing signal to which the sensing result that the first node is requested to report is referring.

According to the method performed by the first node provided by the present disclosure, wherein the first sensing result report indication information includes at least one of: first position request information used for indicating that the first node is requested to report the sensing result obtained in the position indicated by the first position request information, first service request information used for indicating a sensing service to which the sensing result requested to be reported belongs, first node request information used for indicating a node to which the sensing result requested to be reported belongs, and first configuration request information for indicating a configuration of the sensing signal corresponding to the sensing result requested to be reported.

According to the method performed by the first node provided by the present disclosure, wherein the method further comprises: transmitting a first notification message, wherein the first notification message includes at least one of: first sensing result storage indication information used for indicating whether the first node stores the sensing result, first sensing result position information used for indicating a position of a transfer of a sensing signal corresponding to the sensing result stored by the first node, first sensing result service information used for indicating a sensing service corresponding to the sensing result stored by the first node, first sensing result node information used for indicating a node corresponding to the sensing result stored by the first node, and first sensing result configuration information used for indicating a configuration corresponding to the sensing result stored by the first node.

According to an aspect of the present disclosure, there is provided a method performed by a first network node, comprising: starting a transfer of a sensing signal, and transmitting a first message to a first node, wherein the first message includes indication information of a state related to sensing, and the indication information of the state related to sensing includes at least one of: indication information of a state for performing transfer of a sensing signal, and indication information of a state for performing reporting of a sensing result; and wherein the first node is in a non-connected state.

According to the method performed by the first network node provided by the present disclosure, wherein the method further comprises: transmitting a third message to a second network node, wherein the third message is used for indicating information related to sensing to the second network node.

According to the method performed by the first network node provided by the present disclosure, wherein the third message includes at least one of: first resource request information used for requesting the second network node to perform configuration of a sensing resource, first trigger signaling information used for triggering the first node to perform the transfer of a sensing signal; and second trigger signaling information used for triggering the second network node to perform the transfer of a sensing signal.

According to the method performed by the first network node provided by the present disclosure, the first resource request information includes at least one of: identification information for a node, used for indicating a node for which the transfer of a sensing signal needs to be performed; identification information for a node group, used for indicating a node group for which the transfer of a sensing signal needs to be performed; identification information for an area, used for indicating an area for which the transfer of a sensing signal needs to be performed; identification information for a service, used for indicating a sensing service used by a node for which the transfer of a sensing signal needs to be performed; identification information for a sensing signal or type indication information for a sensing signal, used for indicating a triggered sensing signal; sensing performance indication information used for indicating a sensing performance required to be met for the transfer of a sensing signal; and sensing signal resource request information used for indicating resources required for the transfer of a sensing signal.

According to the method performed by the first network node provided by the present disclosure, wherein the sensing signal resource request information includes at least one of: third configuration identification information, used for identifying requested resources; third valid time indication information used for indicating a valid time of requested resources, third sensing type indication information used for indicating a type of the sensing signal served by requested resources, third receiving and transmitting indication information used for indicating a transfer mode of the sensing signal served by the second network node, and third resource indication information used for indicating requested resources.

According to the method performed by the first network node provided by the present disclosure, wherein the method further comprises: receiving a fourth message from a second network node, wherein the fourth message is used for indicating a result of resource allocation for the transfer of a sensing signal.

According to the method performed by the first network node provided by the present disclosure, wherein the fourth message includes at least one of: acceptance indication information used for indicating the sensing signal accepted by the second network device, and rejection indication information used for indicating the sensing signal rejected by the second network device.

According to an aspect of the present disclosure, there is provided a method performed by a second network node, comprising: receiving a third message from a first network node, the third message being used for indicating information related to sensing to the second network node, and transmitting a fourth message to the first network node, the fourth message being used for indicating a result of a resource allocation for transfer of a sensing signal.

According to another aspect of the present disclosure, there is provided a first node, comprising: a transceiver configured to transmit and receive signals with the outside; and a controller configured to control the transceiver to execute the method performed by the first node as described above.

According to another aspect of the present disclosure, there is provided a first network node, the first user equipment comprising: a transceiver configured to transmit and receive signals with the outside; and a controller configured to control the transceiver to execute the method performed by the first network node as described above.

According to another aspect of the present disclosure, there is provided a second network node, the first user equipment comprising: a transceiver configured to transmit and receive signals with the outside; and a controller configured to control the transceiver to execute the method performed by the second network node as described above.

According to another aspect of the present disclosure, there is provided a non-transitory computer-readable recording medium having stored a program thereon, which, when executed by a computer, performs any of the above methods.

According to another embodiment of the disclosure, a method performed by a terminal is provided. The method comprises: receiving, from a base station, a first message triggering a sensing for a group of terminals including the terminal in a radio resource control (RRC) idle state or an RRC inactive state, wherein the first message includes information for indicating the group of terminals; and identifying to start the sensing based on the first message.

According to another embodiment of the disclosure, a method performed by a base station is provided. The method comprises: identifying a group of terminals including a terminal; and transmitting, to the terminal, a first message triggering a sensing for the group of terminals including the terminal in a radio resource control (RRC) idle state or an RRC inactive state, wherein the first message includes information for indicating the group of terminals.

According to another embodiment of the disclosure, a terminal is provided. The terminal comprises: a transceiver; and a controller coupled with the transceiver and configured to: receive, from a base station, a first message triggering a sensing for a group of terminals including the terminal in a radio resource control (RRC) idle state or an RRC inactive state, wherein the first message includes information for indicating the group of terminals, and identify to start the sensing based on the first message.

According to another embodiment of the disclosure, a base station is provided. The base station comprises: a transceiver; and a controller coupled with the transceiver and configured to: identify a group of terminals including a terminal, and transmit, to the terminal, a first message triggering a sensing for the group of terminals including the terminal in a radio resource control (RRC) idle state or an RRC inactive state, wherein the first message includes information for indicating the group of terminals.

### Advantageous Effects of Invention

According to various embodiments of the disclosure, integrated sensing and communication related procedures can be efficiently enhanced, specifically for user equipment (UE) in radio resource control (RRC) inactive state or RRC idle state.

### BRIEF DESCRIPTION OF DRAWINGS

FIG. 1 is an exemplary system architecture of System Architecture Evolution (SAE).

FIG. 2 is an exemplary system architecture according to various embodiments of the present disclosure.

FIG. 3 is a flowchart of a method performed by a first node according to an embodiment of the present disclosure.

FIG. 4 is a schematic diagram of a first node interacting with a second node, a third node and a fourth node according to an embodiment of the present disclosure.

FIG. 5 is a schematic diagram of a first node interacting with a fourth node according to an embodiment of the present disclosure.

FIG. 6 is a schematic diagram of a fifth node interacting with a sixth node according to an embodiment of the present disclosure.

FIG. 7 is a block diagram showing a structure of a first node according to an embodiment of the present disclosure.

FIG. 8 is a block diagram showing a structure of a first network node according to an embodiment of the present disclosure.

FIG. 9 is a block diagram showing a structure of a second network node according to an embodiment of the present disclosure.

### MODE FOR THE INVENTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the following description of various embodiments of the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

The term “include” or “may include” refers to the existence of a corresponding disclosed function, operation or component which can be used in various embodiments of the present disclosure and does not limit the existence of one or more additional functions, operations, or components. The terms such as “include” and/or “have” may be construed to denote a certain characteristic, number, step, operation, constituent element, component or a combination thereof, but may not be construed to exclude the possibility of existence of one or more other characteristics, numbers, steps, operations, constituent elements, components or combinations thereof.

The term “or” used in various embodiments of the present disclosure includes any or all of combinations of listed words. For example, the expression “A or B” may include A, may include B, or may include both A and B.

Unless defined differently, all terms used herein, which include technical terminologies or scientific terminologies, have the same meaning as that understood by a person skilled in the art to which the present disclosure belongs. Such terms as those defined in a generally used dictionary are to be interpreted to have the meanings equal to the contextual meanings in the relevant field of art, and are not to be interpreted to have ideal or excessively formal meanings unless clearly defined in the present disclosure.

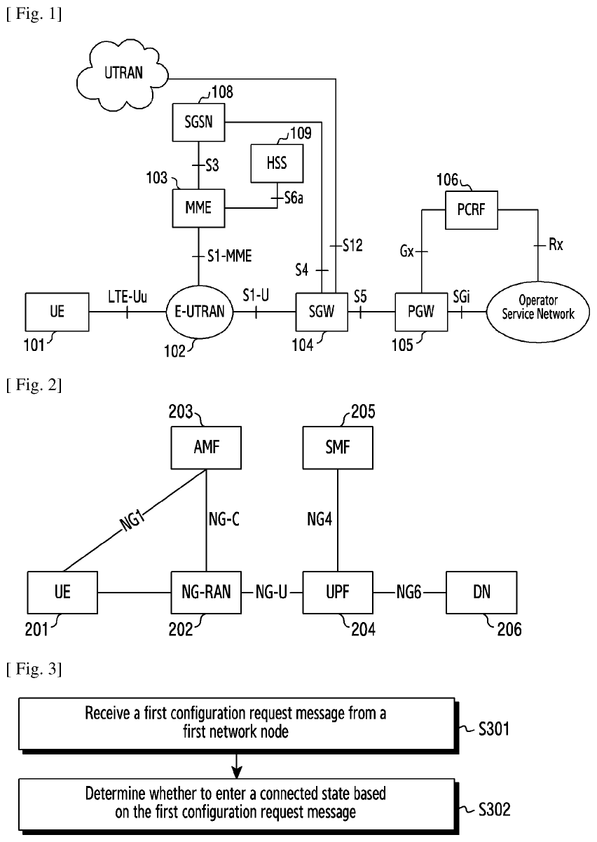

FIGS. 1 to 9 discussed below and various embodiments for describing the principles of the present disclosure in this patent document are only for illustration and should not be interpreted as limiting the scope of the disclosure in any way. Those skilled in the art will understand that the principles of the present disclosure can be implemented in any suitably arranged system or device.

FIG. 1 is an exemplary system architecture 100 of system architecture evolution (SAE). User equipment (UE) 101 is a terminal device for receiving data. An evolved universal terrestrial radio access network (E-UTRAN) 102 is a radio access network, which includes a macro base station (eNodeB/NodeB) that provides UE with interfaces to access the radio network. A mobility management entity (MME) 103 is responsible for managing mobility context, session context and security information of the UE. A service gateway (SGW) 104 mainly provides functions of user plane, and the MME 103 and the SGW 104 may be in the same physical entity. A packet data network gateway (PGW) 105 is responsible for functions of charging, lawful interception, etc., and may be in the same physical entity as the SGW 104. A policy and charging rules function entity (PCRF) 106 provides quality of service (QOS) policies and charging criteria. A general packet radio service support node (SGSN) 108 is a network node device that provides routing for data transfer in a universal mobile telecommunications system (UMTS). A home subscriber server (HSS) 109 is a home subsystem of the UE, and is responsible for protecting user information including a current position of the user equipment, an address of a service node, user security information, and packet data context of the user equipment, etc.

FIG. 2 is an exemplary system architecture 200 according to various embodiments of the present disclosure. Other embodiments of the system architecture 200 can be used without departing from the scope of the present disclosure.

User equipment (UE) 201 is a terminal device for receiving data. A next generation radio access network (NG-RAN) 202 is a radio access network, which includes a base station (a gNB or an eNB connected to the 5G core network 5GC, and the eNB connected to the 5GC is also referred to as ng-gNB) that provides UE with interfaces to access the radio network. An access control and mobility management function entity (AMF) 203 is responsible for managing mobility context and security information of the UE. A user plane function entity (UPF) 204 mainly provides functions of user plane. A session management function entity (SMF) 205 is responsible for session management. A data network (DN) 206 includes, for example, services of operators, access of Internet and services of third parties.

Before introducing the specific content, some assumptions and some definitions of the present invention are given below.
The message names in the present invention are merely examples, and other message names may be used as well.
Terms “first” and “second” contained in the message names of the present invention are merely examples of messages, and do not represent the execution order.
Detailed illustration of steps irrelevant to the present invention is omitted in the present invention.
In the present invention, the steps in each process may be executed either in combination with each other or independently. The execution steps of each process are merely examples, and other possible execution orders are also possible.
In the present invention, the base station may be a 6G base station, a 5G base station (such as gNB and ng-eNB), a 4G base station (such as eNB), or other types of access nodes.
In the present invention, a transfer of a sensing signal includes reception and/or transmission of a sensing signal.

The nodes involved in the present invention are as follows:
First Node: The first node may be user terminal equipment.
Second Node: The second node may be a network node device. In an example, the second node may be a base station. In another example, the second node may be an access point. In yet another example, if a base station contains multiple parts, the second node may be a part of the base station, such as a central unit of the base station, a control plane part of the centralized unit of the base station, a user plane part of the centralized unit of the base station, etc.
Third Node: The third node may be a second node, or a fourth node, or a network node device different from the second node and/or the fourth node.
Fourth Node: The fourth node may be a second node, or a third node, or a network node device different from the second node and/or the third node. In an example, the second node may be a base station. In another example, the second node may be an access point. In yet another example, if a base station contains multiple parts, the second node may be a part of the base station, such as a central unit of the base station, a control plane part of the centralized unit of the base station, a user plane part of the centralized unit of the base station, etc.
Fifth Node: The fifth node may be a part of the base station, such as a centralized unit of the base station, or a control plane part of the centralized unit of the base station. In the following description, a centralized unit of the base station is taken as an example.
Sixth Node: The sixth node may be another part of the base station, which is different from the fifth node, such as a distributed unit of the base station. In the following description, a distributed unit of the base station is taken as an example.

The base stations involved in the above nodes may be one or more of the following types, and other types that may be used for user terminal access are also possible:
a Long term evolution (LTE) base station
a 5G base station
a 6G base station
an NTN (Non-terrestrial Network) base station
a HAPS (high altitude platform station) base station
a Drone base station
a WIFI (wireless network) access point

Exemplary embodiments of the present disclosure are further described below with reference to the accompanying drawings.

The text and drawings are provided as examples only to help understand the present disclosure. They should not be interpreted as limiting the scope of the present disclosure in any way. Although certain embodiments and examples have been provided, based on the disclosure herein, it will be apparent to those skilled in the art that changes may be made to the illustrated embodiments and examples without departing from the scope of the present disclosure.

In the future 6G network, Integrated Sensing and Communication will become one of the representative technologies, which mainly assists data transfer in the communication system through sensing of surrounding objects by radio waves. On one hand, a sensing function can help improve the performance of data transfer for the communication system. On the other hand, since the base station or user terminal needs to perform signal sensing in addition to data transfer, it also adds extra overhead to some extent. Therefore, the performance optimization of sensing and communication has become one of significant research directions in Integrated Sensing and Communication.

In addition, in the Integrated Sensing and Communication system, the base station and the user terminal will utilize a sensing signal for sensing. The reception and transmission of a sensing signal may include the following modes: 1) the base station transmitting and the base station receiving, 2) the base station transmitting and the terminal receiving, 3) base station A transmitting and base station B receiving, 4) the terminal transmitting and the terminal receiving, 5) the terminal transmitting and the base station receiving, and 6) terminal A transmitting and terminal B receiving. Some of these modes require participation of user terminals. When the terminal is in a connected state, the base station can configure how the user terminal perform reception and transmission of a sensing signal through signaling in a connected state (i.e., connected status).

However, when the terminal is in a non-connected state (such as an idle state and an inactive state), the base station cannot learn information at a user terminal side, so the base station cannot well configure terminal's reception and transmission of a sensing signal, for example, the terminal cannot learn neither when to start performing the reception and transmission of a sensing signal, nor what resources to performing the reception and transmission of a sensing signal on.

A feasible method is that the base station causes the terminal to enter the connected state through signaling, and then configures the user to perform reception and transmission of a sensing signal, which may add too much signaling overhead for the user terminal and bring about more energy consumption.

The present invention proposes a mechanism for a user terminal in a non-connected state to receive and transmit the triggering and configuring of a sensing signal. By means of this mechanism, the user terminal in the non-connected state can be triggered to perform reception and transmission of a sensing signal, so that the terminal equipment in the non-connected state can perform reception and transmission of a sensing signal according to the triggering signal or information after receiving the triggering signal or information transmitted by the base station. This solution can effectively reduce energy consumption for users when performing reception and transmission of a sensing signal, and reduce signaling overhead.

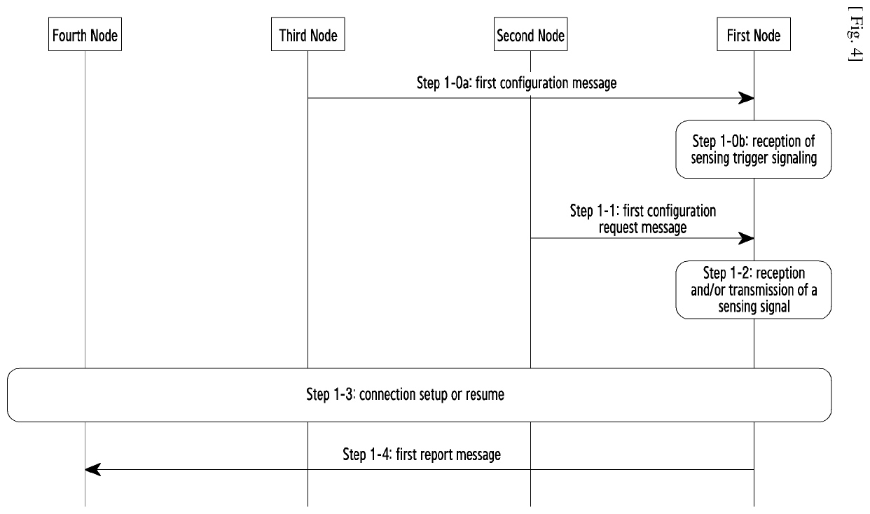

Next, a method performed by a first node provided by an embodiment of the present disclosure will be described with reference to FIG. 3. FIG. 3 is a flowchart of a method performed by a first node according to various embodiments of the present disclosure. The method performed by the first node may include steps S301 and S302.

Step S301: A first node receives a first message from a first network node.

As an implementation, the first node may be a user terminal, and the user terminal is in a non-connected state (such as an idle state and an inactive state).

As an implementation, the first network node may be a second node or a third node or a fourth node or a fifth node.

As an implementation, the first message includes indication information of a state related to sensing, and the indication information of the state related to sensing includes at least one of: indication information of a state for performing transfer of a sensing signal, and indication information of a state for performing reporting of a sensing result.

Step S302: The first node determines whether to enter a connected state based on the first message.

Through the above mechanism, the user terminal in the non-connected state can receive the first message from the first network node, the first message includes the indication information of the state related to sensing, and the indication information of the state related to sensing includes at least one of: the indication information of the state for performing transfer of a sensing signal and the indication information of the state for performing reporting of the sensing result, so that the user terminal may determine whether to enter the connected state based on the first message when in the non-connected state. Therefore, the user terminal does not need to enter the connected state through base station's configuration before performing reception and transmission of a sensing signal, thereby effectively reducing energy consumption for user terminal when performing reception and transmission of a sensing signal and reducing signaling overhead.

Next, illustrations will be made with respect to interaction of messages between various nodes and detailed contents of the messages provided by the embodiments of the present disclosure, with reference to FIGS. 4 to 7.

FIG. 4 is a schematic diagram of a first node interacting with a second node, a third node and a fourth node according to an embodiment of the present disclosure. The method of the embodiment of the present disclosure may include the following steps:

Step 1-1: The second node transmits a first configuration request message to the first node (a user terminal) (it can be understood that the message name is not a limitation to the present application, for example, a first configuration request message may also be referred to as a first message etc., and any message that achieves the same effect or contains the same content belongs to the scope of the present invention, and the following message types will not be detailed), and this message is used to indicate information related to sensing to the first node, i.e., to configure the first node to perform reception and/or transmission of a sensing signal. In an example, when the first node is in the non-connected state, the base station may utilize this message to indicate the user terminal to perform reception and/or transmission of a sensing signal. In another example, when the first node is in the non-connected state, the base station may utilize this message to indicate state information of the user terminal for performing reception and/or transmission of a sensing signal, such as whether it is required to enter the connected state (e.g., the user terminal may perform reception and/or transmission of a sensing signal after entering the connected state) and a condition for entering the connected state. One beneficial effect of this message is that the reception and transmission of a sensing signal of the user terminal (in the non-connected state) is triggered, the signaling overhead of the user terminal is reduced and the energy consumption is also reduced. Another beneficial effect is that the user terminal (in the non-connected state) is triggered to perform reception and/or transmission of a sensing signal after entering the connected state, so that a timely transmission and/or reception of a sensing signal can be guaranteed, ensuring the sensing performance. Before step 1-1, it further comprises that the second node determines to start the first node to perform reception and/or transmission of a sensing signal. In an example, the second node determines to start by itself. In another example, the second node starts according to a message (whose content may be made with reference to the content in the first configuration request message) received from other nodes. In an example, the information contained in this message may be “indication information of a state related to sensing”. In a mode, the first node may utilize the information contained in this message to perform transfer of a sensing signal. In another mode, the information contained in this message is used for indicating the information contained in the following “first configuration message”, and then the first node performs the transfer of a sensing signal by combining this message and the information in the following “first configuration message”. The first configuration request message may contain at least one of the following information:
First state indication information, which indicates state information of the first node for performing reception and/or transmission of a sensing signal. In an example, this information indicates a required (connected) state (such as an RRC (Radio Resource Control) state), i.e., whether it is required to enter the connected state to perform the reception and/or transmission of a sensing signal. In another example, this information may also be used for indicating the condition for the first node to enter the connected state. In an example, if this indication information indicates that it is not required to enter the connected state (i.e., being in the non-connected state is allowable) to perform the reception and/or transmission of a sensing signal, the first node performs the reception and/or transmission of a sensing signal according to its obtained configuration information (such as other information contained in the “first configuration request message”). In another example, if this indication information indicates that it is required to enter the connected state, the first node will trigger a process of connection setup or resume. When the first node needs to enter the connected state, one example is that the first node starts the process of entering the connected state according to the “first state indication information”, and then performs reception and/or transmission of a sensing signal after the first node enters the connected state; and another example is that the first node also performs reception and/or transmission of a sensing signal when being in the non-connected state, and the first node will start the process of entering the connected state after the condition information indicated by the “first state indication information” is met. The configuration information used by the first node to perform the reception and/or transmission of a sensing signal may be other information contained in the “first configuration request message”. In an example, the “configuration information used to perform the reception and/or transmission of a sensing signal” is transmitted before the first node enters the connected state, such as transmitted by the above the “first configuration request message”. In another example, the “configuration information used to perform the reception and/or transmission of a sensing signal” is transmitted after the first node enters the connected state, and the used message may be an RRC message, such as an RRCReconfiguration message, an RRCSetup message, an RRCResume message, or another type of message. The “first state indication information” may be an explicit indication or an implicit indication (such as indicated by the “first configuration request message” or the information contained in the “first configuration request message”). The beneficial effects of this indication information are that: the first node can determine its state when performing reception and/or transmission of a sensing signal, and guarantee proper reception and/or transmission of a sensing signal. This information may also include at least one of the following information:
   First state identification information, which identifies a set of configuration information in the above “first state indication information”, or a set of configurations in the following “second state indication information”. In an example, the first node may determine the state information of the first node for performing reception and/ or transmission of a sensing signal according to “second state indication information” in the following “first configuration message” and the “first state identification information”. For example, if the above “first state identification information” is the same as the “second state identification information” in the first configuration message, the first node may report according to a configuration in fourth state indication information corresponding to the “first state identification information”.
   Connection state indication information, which indicates that the user terminal needs to enter the connection state. In an example, the first node needs to perform the reception and/or transmission of a sensing signal after entering the connection state. This information has beneficial effects of ensuring that the first node can receive and/ or transmit a sensing signal, ensuring proper reception and/or transmission of a sensing signal, and guaranteeing the sensing performance.
   Time indication information, which indicates a time required to wait for the user terminal before starting the process of entering the connected state (such as the connection setup and the connection resume). In an example, the first node will start a timer with a length indicated by this information, and upon the expiration of the timer, the first node starts the process of entering the connected state. This information has beneficial effects of ensuring that the user terminal can perform reception and/or transmission of a sensing signal after entering the connected state, and guaranteeing the performance of reception and transmission of a sensing signal.
   State trigger indication information, which indicates a condition required to be met for the first node to start the process of entering the connected state. After receiving this information, the first node may first determine whether the condition indicated by this indication information is met, and only when it is met, the first node will trigger the process of the connection setup or resume. This information has beneficial effects of reducing the signaling overhead when the first node performs reception and/or transmission of a sensing signal, and ensuring proper reception and/ or transmission of a sensing signal as well. This indication information may include at least one of the following information:
      Threshold information for a signal, which may be a threshold of a strength (such as RSRP (a reference signal received power), a signal quality (such as RSRQ (a reference signal received quality)), and a signal energy strength) of a signal (such as a sensing signal or another signal) received by the first node. The first node will start the process of entering the connected state only when the measurement result of the sensing signal exceeds the threshold;
      Threshold information for a number of times for receiving signals. The first node will start the process of entering the connected state only after the number of times for receiving signals (such as sensing signals) exceeds the number of times indicated by this information;
      Threshold information for a number of times for transmitting signals. The first node will start the process of entering the connected state only after the number of times for transmitting signals (such as sensing signals) exceeds the number of times indicated by this information;
      Position indication information, which indicates the position of the first node when starting the process of entering the connected state. In an example, this information indicates an area, so the position information may be area ID, cell ID, cell group ID, RNA ID, TA ID, sensing area ID, etc. The first node will start the process of entering the connected state only after entering the area;
      Service indication information, which indicates the supported or configured services of the user who needs to start the process of entering the connected state, that is, the first node will start the process of entering the connected state only when the supported or configured services of the first node are the services indicated by this information. In an example, the services indicated by this information is a sensing service, such as a sensing service ID, a sensing application ID, etc.;
      User's indication information, which indicates the user who starts the process of entering the connected state. This information may be identification information for the user, identification information for the user group, etc. In an example, this information may be the information contained in the following “first node indication information”;
First node indication information (also referred to as first user indication information), which indicates the user who performs reception and/or transmission of a sensing signal. In an example, the user may perform the reception and/or transmission of a sensing signal in the non-connected state. In another example, the user may perform the reception and/or transmission of a sensing signal after entering the connected state. After receiving this information, the first node may determine whether it needs to perform the reception and/or transmission of a sensing signal. In an example, the first node will utilize this information to compare it with pre-configured information, and in turn determine whether to trigger the first node to perform the reception and/or transmission of a sensing signal. This information has beneficial effects of: determining a user who needs to perform the reception and/or transmission of a sensing signal, improving the sensing performance and reducing unnecessary signal reception and transmission by other users. This information may include at least one of the following information:
   Identification information for a first node (also referred to as identification information for a first user), such as TMSI, I-RNTI, sensing ID and sensing-RNTI. If the first node is the user indicated by this information, the first user needs to perform the reception and/or transmission of a sensing signal, or otherwise, the first node does not need to perform the reception and/or transmission of a sensing signal. In an example, if the above “identification information for a first user” has been pre-configured to the first node (e.g., configured to the first node through the “identification information for a second node” in the following step 1-0a), it means that the first configuration request message triggers the first node to perform the reception and/or transmission of a sensing signal.
   Identification information for a first node group (also referred to as identification information for a first user group), such as UE group ID, sensing group ID, which indicates a user group that receives and/or transmits sensing signals, and this user group contains one or more users. In an example, if the above “identification information for a first user group” has been pre-configured to the first node (e.g., configured to the first node through the “identification information for a second node group” in the following step 1-0a), it means that the first configuration request message triggers the users (including the first node) of the user group to which the first node belongs to perform the reception and/or transmission of a sensing signal, and in turn the first node needs to perform the reception and/or transmission of a sensing signal.
   Identification information for a first area, such as area ID, RAN notification area ID (RNA ID), Tracking Area ID (TA ID), sensing area ID, cell ID, cell group ID, etc. This information indicates an area in which the reception and/or transmission of a sensing signal is performed if the first node is in the area. In one implementation, the first node may determine whether it is in the area indicated by this information according to its positioning function. In another implementation, if the above “identification information for a first area” is pre-configured to the first node (e.g., configured to the first node through the “identification information for a second area” in the following step 1-0a), it means that the first configuration request message triggers the users (including the first node) in the area where the first node is located to perform the reception and/or transmission of a sensing signal.
   Identification information for a first service, such as sensing service ID, sensing application ID, etc. In an example, if the first node is using the sensing service indicated by the “identification information for a first service”, the first node needs to perform the reception and/or transmission of a sensing signal. In another example, if the above “identification information for a first service” is pre-configured to the first node (e.g., configured to the first node through the “identification information for a second service” in the following step 1-0a), it means that the first node needs to perform the reception and/or transmission of a sensing signal.
   Identification information for a first sensing signal, which indicates a triggered sensing signal. In an example, if the above “identification information for a first sensing signal” is pre-configured to the first node (e.g., configured to the first node through the “identification information for a second sensing signal” in the following step 1-0a), it means that the first node needs to perform the reception and/or transmission of a sensing signal.
   Third state indication information, which indicates the state information of the node indicated by the above “first node indication information” when performing the reception and/or transmission of a sensing signal. The information contained in this information may be made with reference to the above “first state indication information”.
First sensing signal related information, which indicates the configuration information required for the user terminal to perform the reception and/or transmission of a sensing signal. After receiving this information, the first node may determine how to perform the reception and/or transmission of a sensing signal. This information has beneficial effects of: helping the user terminal to determine resources for receiving and transmitting the sensing signal, guaranteeing proper reception and transmission of a sensing signal, and completing the sensing function. The information includes at least one of the following information:
   Identification information for configuration of a first sensing signal, which indicates a set of configuration information related to sensing, such as one or more pieces of information contained in the above “first sensing signal related information”. The correspondence between the identification information for configuration and the specific “configuration information related to sensing” may be configured to the user before step 1-1 (e.g., configured to the user through a system message, or configured to the user through a control message of the user terminal, or configured to the user through the following step 1-0a).
   First valid time indication information, such as time range information, time starting point information, time length information, etc. This information indicates the valid time of one or more configurations contained in the above “first sensing signal related information”, that is, the user terminal only needs to perform the reception and/or transmission of a sensing signal according to the one or more configurations contained in the above “first sensing signal related information” within the time range indicated by this indication information. In an example, this information indicates a specific time range, and the starting position of the range is also determined (or fixed). In another example, the starting position of the time range may be dynamically changed, such as a position when a certain event (e.g. receiving the above “first configuration request message” or receiving the information that triggers the reception and/or transmission of a sensing signal) occurs. Further, upon the occurrence of a certain event, the user terminal may start a timer whose length is the length indicated by the “first valid time indication information”. Upon the expiration of the timer, the user terminal stops the reception and/or transmission of a sensing signal.
   First sensing type indication information, which indicates the type of the reception and/or transmission of a sensing signal performed by the first node. After receiving this information, the first node may determine whether it needs to perform the reception and/or transmission of a sensing signal. This information has beneficial effects of: helping the user terminal to determine the receiving and transmitting mode of a sensing signal, ensuring properly processing of a sensing signal and avoiding causing interference. The types that the information can indicate include at least one of the following types:
      The base station receives and transmits sensing signals;
      The base station transmits and the terminal receives;
         Base station A transmits and base station B receives;
      The terminal transmits and the terminal receives;
      The terminal transmits and the base station receives;
      Terminal A transmits and terminal B receives.
   First receiving and transmitting indication information, which indicates a transferring mode for a sensing signal. After receiving this information, the first node may determine a mode for receiving and transmitting a sensing signal. The information has beneficial effects of: helping the user terminal to determine the reception and/or transmission of a sensing signal, guaranteeing properly processing of a sensing signal and avoiding the interference caused by the sensing signal. The information may be indicated in at least one of the following modes: 1) transmitting sensing signals, 2) receiving sensing signals, 3) receiving and transmitting sensing signals;
   First sensing enable indication information, which indicates whether the user terminal needs to perform the reception and/or transmission of a sensing signal. In an example, this information may be cause information, i.e., a cause for transmitting the above “first configuration request message”.
   First synchronization indication information, which indicates whether the user terminal needs to perform synchronization when performing the reception and/or transmission of a sensing signal (the synchronization may be downlink synchronization, uplink synchronization, or both uplink and downlink synchronization). After receiving this information, the first node may determine a synchronization operation required to be performed when performing the reception and/or transmission of a sensing signal. This information has beneficial effects of: helping the user terminal to properly perform the transmission and reception of a sensing signal, and guaranteeing the sensing performance.
   Configuration information of a first sensing signal, which indicates resource configuration information of the sensing signal. After receiving this information, the user terminal may determine how to properly perform the reception and/or transmission of a sensing signal. In an example, this information indicates the configuration of the sensing signal received by the user terminal. In another example, this information indicates the configuration of the sensing signal transmitted by the user terminal, such as a configuration of configured grant and a configuration of sensing-configured gran. In another example, this information indicates a configuration of the sensing signals received and transmitted by the user terminal. This information has beneficial effects of: helping the user terminal to determine how to perform the reception and/or transmission of a sensing signal (such as resources for performing the reception and/or transmission of a sensing signal), and ensuring proper reception and transmission of a sensing signal. This information includes at least one of the following information:
      Resource configuration indication information, which indicates information of one or more configurations (such as information of one or more configurations contained in the “configuration information of a sensing signal”) of resources used for performing reception and/or transmission of a sensing signal. In an example, this indication information may be a configured identification information. After receiving this information, the user terminal may know the configuration of the sensing signal. In an example, the configuration of the sensing signal may be configured to the user terminal before step 1-1 (e.g., configured to the user through the following step 1-0a), and the configuration of the sensing signal may be determined through the above “resource configuration indication information”.
      Sequence indication information, which indicates information of the sequence used when transmitting the sensing signal, such as a gold sequence.
         Time domain resource information, which indicates a configuration of resources on time domain for receiving and/or transmitting sensing signals by the user. This information includes at least one of the following information:
         Periodic information, such as a periodicity and cycle.
         Reference time domain position indication information, such as reference time, a super-frame number, etc.
         Offset information, such as an offset and start offset, which indicates an offset relative to a reference position (which may be the position indicated by the above “reference time domain position indication information” or an implicitly indicated position) when the user receives and/or transmits sensing a signal, and also indicates an offset within a time interval (such as a subframe, a frame, a time slot, etc.) (such as indicating which symbol, which time slot, which subframe, etc. in the time interval).
         Time length information, which indicates a time length for performing the reception and/or transmission of a sensing signal, such as in milliseconds, number of symbols, etc.
      Frequency domain resource information, which indicates a configuration of resources on frequency domain for receiving and/or transmitting a sensing signal by the user. This information includes at least one of the following information:
         Carrier frequency information, which indicates a carrier frequency where the received and/or transmitted sensing signal is located. For the transmission of a sensing signal, this information may also be used for indicating whether it is a normal uplink carrier (NUL) or a supplementary uplink carrier (SUL).
         Carrier spacing information, which indicates a subcarrier spacing used for the sensing signal.
         Frequency domain range information, which indicates a range in frequency domain where the sensing signal is located. This information may include at least one of the following information:
         Identification information for a bandwidth range, such as bandwidth part ID;
         Position information of a starting point of a frequency domain range, such as frequency point information, serial number information of subcarriers, serial number information of resource blocks, serial number information of subcarriers, serial number information of subbands, etc.
         Position information of an ending point of a frequency domain range, such as frequency point information, serial number information of subcarriers, serial number information of resource blocks, serial number information of subcarriers, serial number information of subbands, etc.
         Size information of a frequency domain range, such as bandwidth information, information of number of subcarriers, information of number of resource blocks, etc.
      Spatial resource information, which indicates a configuration of resources on spatial domain for receiving and/or transmitting sensing signals by the user. This information includes at least one of the following information:
         Beam indication information, such as beam ID and TCI (transmission configuration indicator). This information indicates the beam required for the received and/or transmitted sensing signal.
         Associated beam indication information, which indicates a beam associated with the beam used for receiving and/or transmitting a sensing signal. In an example, this information may indicate a beam of an associated synchronization signal, such as a SSB (Synchronization Signal block).
   Fourth state indication information, which indicates the state information of the first node when performing the reception and/or transmission of the sensing signal indicated by the above “first sensing signal related information”. The information contained in this information may be made with reference to the above “first state indication information”.
First report indication information, which indicates the information for the first node to report the sensing result, such as a condition required to be met when reporting the result, when the sensing result needs to be reported, etc. In an example, if the user equipment is in the non-connected state, in order to report the sensing result, the user equipment needs to enter the connected state, and this information is used to indicate the condition required to be met for the first node to enter the connected state for reporting the sensing result. The report indication information may be given according to different sensing signals, that is, for different sensing signals, there are different report indication information. This information has beneficial effects of: determining the condition for the first node to report the sensing result, reducing an unnecessary connection setup process and reducing the energy consumption and signaling overhead of the first node. This information includes at least one of the following information:
   First report identification information, which identifies a set of configuration information in the above “first report indication information”, or a set of configurations in the following “second report indication information”. In an example, the first node may determine the information for the first node to report the sensing result according to the “second report indication information” in the following “first configuration message” and the “first report identification information”. For example, if the above “first report identification information” is the same as the “second report identification information” in the first configuration message, the first node may report according to a configuration in the second report indication information corresponding to the “first report identification information”.
   First trigger time indication information, which indicates a time length required to be experienced by the first node before performing the reporting of sensing result. In an example, the first node will trigger a timer with the time length indicated by this information. Upon the expiration of the timer, the first node may start a process of reporting the sensing result (such as a process of setting up a connection, process of resuming a connection, etc.), or the first node may report the measurement result of the sensing signal to the upper layer protocol (such as an upper layer), and in turn the upper layer protocol determines whether to trigger the process of reporting the sensing result. This information has beneficial effects of: ensuring proper reception of a sensing signal, and reducing unnecessary signaling overhead and energy consumption. The timer can be started under at least one of the following conditions:
      The above “first configuration request message” is received;
      The sensing signal is received for the first time. In an example, this condition may occur after the sensing signal has been transmitted for a period of time, that is, when the network side starts transmitting the sensing signal, the first user does not receive the sensing signal (or does not demodulate or detect the sensing signal) due to reasons such as signal quality etc., and the first user receives the sensing signal after a time period.
      The sensing signal is transmitted for the first time;
      The reception and/or transmission of the sensing signal is started;
   First trigger condition indication information, which indicates a condition required to be met for the first node to perform the reporting of sensing result. After receiving this information, the first node will first determine whether the condition indicated by this indication information is met, and only when it is met, the first node will report. In an example, only after the condition indicated by this indication information is met, the first node will trigger the process of connection setup or resume to perform the report of sensing result. This information has beneficial effects of: reducing the signaling overhead and energy consumption caused by the reporting of sensing result. This indication information may include at least one of the following information:
      Threshold information for a measurement result of a first sensing signal, which may be a threshold of the strength of the sensing signal (such as a RSRP (reference signal received power)), or a threshold of a signal quality (such as RSRQ), etc. The first node will report only when the measurement result of the sensing signal exceeds the threshold;
      Threshold information for a number of times for receiving a first sensing signal. The first node will report only after the number of times for receiving a sensing signal exceeds the number of times indicated by this information;
      Threshold information for a number of times for transmitting a first sensing signal. The first node will report only after the number of times for transmitting a sensing signal exceeds the number of times indicated by this information;
      Threshold information for a resolution of a first sensing signal. The first node will report only after the sensing resolution exceeds the threshold indicated by this information;
      Threshold information for an accuracy of a first sensing signal. The first node will report only after the accuracy of the sensing signal exceeds the threshold indicated by this information;
      First sensing report indication information, which indicates configuration information of the sensing signal for which the reporting of sensing result needs to be performs, that is, the first node will determine the sensing result required to be reported according to this information. This information includes at least one of the following information:
         Position information of reporting of a first sensing result, which indicates the position of the first node when performing the reporting of sensing result. In an example, this information indicates an area, the position information may be area ID, cell ID, cell group ID, RNA ID, TA ID, sensing area ID, etc. The first node will perform the reporting of sensing result only after entering the area;
         Position information of reception and transmission of a first sensing signal, which indicates the position of the reception and transmission of the sensing signal to which the sensing result reported by the first node is referring. This information may be area ID, cell ID, cell group ID, RNA ID, TA ID, sensing area ID, etc. The first node only reports the sensing result obtained in the position indicated by this information;
         First sensing service indication information, which indicates the sensing service to which the sensing result reported by the first node belongs, such as sensing service ID, sensing application ID, etc. In an example, the first node only reports the sensing result of the service indicated by this information;
         First reporting user indication information, which indicates the user who reports the sensing result. This information may be identification information for a user, identification information for a user group, etc.
         When the above “first trigger condition indication information” contains multiple conditions, the first node can perform the reporting of sensing result only when all the multiple conditions are met.
   First delayed connection indication information, which indicates that the user terminal can delay entering the connected state. In an example, this information indicates that the user terminal can delay performing the reporting of the sensing result. In another example, if the first configuration request message received by the user terminal contains this information, the user can delay the process of starting the connection setup or resume. This information may be either explicit indication information, or implicit indication information (e.g., it is implicitly indicated, through the above “first configuration request message” or the information contained in the “first configuration request message”, that the user terminal can delay entering the connected state or delay performing the reporting of the sensing result).
First configuration identification information, or first configuration index information, which is used to identify a group of configurations related to sensing. The configuration may be at least one of the above “first state indication information”, “first node indication information”, “first sensing signal related information” and “first report indication information”. In an example, the first node obtains a configuration related to sensing through the following “first configuration message” (including at least one of the following “second state indication information”, “second node indication information”, “second sensing signal related information” and “second report indication information”, and these configurations will be indicated through the following “second configuration identification information”). If the “first configuration identification information” is the same as the following “second configuration identification information”, the first node will perform the transfer of a sensing signal according to the configuration represented by the “first configuration identification information” contained in the “first configuration message”. This information has beneficial effects of: reducing the configuration signaling required for the user terminal in the non-connected state to perform the transfer of a sensing signal.

The above first configuration request message is used to trigger the first node to start performing reception and/or transmission of a sensing signal, and may be referred to as sensing trigger signaling (in the following description, the sensing trigger signaling is also the above “first configuration request message”). In an example, the sensing trigger signaling may be an RRC message (such as a paging message, a system message, etc.). In another example, the sensing trigger signaling may be signaling of a physical layer, such as downlink control information. In another example, the sensing trigger signaling may also be signaling of other protocol layers (such as a control element of MAC (Media Access Control) layer). When the above “first configuration request message” is a paging message, after receiving this message, the first node will on one hand trigger the reception and/or transmission of a sensing signal, and on the other hand will delay the process of the connection setup or resume according to the information contained in the paging message. In addition, in one implementation, the above first configuration request message may be from an entity of the core network, for example, transmitted by the entity of the core network to the second node, and then transmitted by the second node to the first node. In another implementation, the above first configuration request message may be from other base stations, for example transmitted by the other base stations to the second node, and then transmitted by the second node to the first node. In another implementation, the above first configuration request message may be from a centralized unit of the base station or a control plane part of the centralized unit, for example, transmitted by the centralized unit of the base station or the control plane part of the centralized unit to the second node (a distributed unit of the base station), and then transmitted by the second node to the first node.

In an example, at least one of the above “first state indication information”, “first node indication information” and “first sensing signal related information” may be referred to as “indication information of the state for performing the transfer of a sensing signal”, and the above “first report indication information” may be referred to as “indication information of the state for performing reporting of a sensing result”.

Then, the first node performs the reception and/or transmission of a sensing signal based on the “first configuration request message”. An example of the first node performing the reception and/or transmission of a sensing signal based on the information of the “first configuration request message” is as follows:

Example 1 (The reception and/or transmission of a sensing signal is not performed in the non-connected state, and whether it is required to perform the reception and/ or transmission of a sensing signal after entering the connected state is determined according to the “first configuration request message”): The first node will determine its state when performing the reception and/or transmission of a sensing signal based on the “first configuration request message”. If the above “first configuration request message” (such as “first state indication information”) indicates that the first node needs to perform the reception and/or transmission of a sensing signal after entering the connected state, the first node will start the process of the connection setup or resume to enter the connected state, and then perform the reception and/or transmission of the sensing signal. The first node will not perform the reception and/or transmission of a sensing signal before entering the connected state.

Example 2 (The reception and/or transmission of a sensing signal is performed in the non-connected state, and determining whether it is required to enter the connected state according to the “first configuration request message”): The first node will perform the reception and/or transmission of a sensing signal based on the “first configuration request message”, and then determine whether the condition for entering the connected state (such as the condition indicated by the above “time indication information”, and the condition indicated by the above “state trigger indication information”) is met, and won't start the process of entering the connected state until the condition is met.

Example 3 (The reception and/or transmission of a sensing signal is performed in the non-connected state, without entering the connected state): The first node will perform the reception and/or transmission of the sensing signal in the non-connected state based on the “first configuration request message”, and the “first configuration request message” also does not contain the information used by the first node to determine the condition for entering the connected state (such as the condition indicated by the above “time indication information”, the condition indicated by the above “state trigger indication information”, and the condition indicated by the above “first report indication information”), then the first node won't enter the connected state.

The above three examples indicate that, the first node can perform the reception and/ or transmission of the sensing signal in the non-connected state, or the first node needs to enter the connected state before performing the reception and/or transmission of a sensing signal, or the first node performs the reception and/or transmission of a sensing signal in the non-connected state and will start the process of entering the connected state (such as the process of setting up a connection and the process of resuming connection) after the condition is met. The above three examples have beneficial effects that: the first node can determine the state when performing the reception and/or transmission of a sensing signal, reduce unnecessary signaling overhead, and guarantee proper reception and/or transmission of a sensing signal.

By triggering the reception and transmission of a sensing signal for the user terminal (in the non-connected state) through the above first configuration request message, the signaling overhead of the user terminal can be reduced, and the energy consumption can be reduced. Further, the user terminal can determine whether to enter the connected state to perform the reporting of the sensing result. Furthermore, through the first state indication information contained in the above first configuration request message, the state when performing the reception and/or transmission of a sensing signal can be determined, and proper reception and/or transmission of a sensing signal can be guaranteed. Furthermore, through the first node indication information included in the above first configuration request message, the user who needs to perform the reception and/or transmission of a sensing signal can be determined, the sensing performance can be improved, and unnecessary signal reception and transmission by other users can be reduced. Furthermore, through the first sensing signal related information included in the first configuration request message, the user terminal can be helped to determine the resources for receiving and transmitting sensing signals, proper reception and transmission of a sensing signal can be guaranteed, and the sensing function can be completed. Furthermore, through the first report indication information included in the above first configuration request message, the condition for the first node to perform the reporting of the sensing result is determined, the unnecessary connection setup process is reduced, and the energy consumption and signaling overhead of the first node are further reduced. Moreover, the present disclosure also provides a variety of different implementations of the first configuration request message, which makes the implementation of the first configuration request message more flexible and can adapt to more scenarios.

It can be understood that before the second node transmits the first configuration request to the first node, the second node may further include, for example, a step of starting the transfer of a sensing signal.

As an implementation, when the first node is in a non-connected state (e.g., an idle state, an inactive state), in order to receive the above “first configuration request message”, the present disclosure provides a method for the first node to obtain configuration information for receiving the sensing trigger signaling. In addition, the information contained in the above “first configuration request message” may also be pre-configured to the first node, so that the first node can determine the specific configuration for reception and/or transmission of a sensing signal after receiving the “first configuration request message”. Therefore, optionally, please continue to refer to FIG. 4, before Step 1-1, the configuration information for configuring the first node to perform reception of the sensing trigger signaling and the configuration information required for the first node to perform the reception and transmission of a sensing signal may also be included:

Step 1-0a: The third node (of course, it can also be another node, such as the second node, the fourth node, etc.) transmits a first configuration message to the first node (it can be understood that the message name is not a limitation to the present application, for example, the first configuration message may also be referred to as a second message, etc., and any message that achieves the same effect or contains the same content belongs to the scope of the present invention, and the following message types will not be detailed). This message is used to configure how the first node receives the sensing trigger signaling, and in addition, it may also be used to indicate the configuration required for the first node to perform the reception and/or transmission of a sensing signal. This message has beneficial effects of: helping the user equipment in the non-connected state to obtain the sensing trigger signaling and/or the configuration information of reception and/or transmission of a sensing signal, and reducing the signaling overhead and energy consumption for the user before receiving and/or transmitting sensing signals. This message may include the configuration information of the sensing trigger signaling as well as the configuration information of the sensing signal. Such information may be given either for different sensing signals respectively, or for all of the sensing signals. For a type of a sensing signal, the first configuration message includes at least one of the following information:
Second state indication information, which indicates the state information of the first node when performing the reception and/or transmission of a sensing signal. In an example, this information indicates the required (connected) state (such as an RRC state), that is, whether it is required to enter the connected state to perform the reception and/or transmission of a sensing signal. In another example, this information may also be used for indicating the condition for the first node to enter the connected state. The information contained in this information may be made with reference to the above “first state indication information”. In order to identify this information, this information may contain the “second state identification information”. The description of this information may be made with reference to the above “first state indication information”.
Second node indication information (also referred to as second sensing signal indication information). In an example, this information indicates a type of a sensing signal. In another example, this information is used to help the first node determine whether it is required to perform the reception and/or transmission of a sensing signal. The description of this information may be made with reference to the above “first node indication information”.
Second sensing signal related information (also referred to as configuration information of a second sensing signal), which indicates the configuration information of the received and/or transmitted sensing signal. Based on this information, the first node may learn how to perform the reception and/or transmission of a sensing signal. In addition, after the first node obtains the sensing trigger signaling, it may finally determine the configuration for the received and/or transmitted sensing signal according to the information in the sensing trigger signaling and the information contained in the configuration information. In an example, this information indicates the configuration of the sensing signal received by the user terminal. In another example, this information indicates the configuration of the sensing signal transmitted by the user terminal, such as the configuration of the configured grant and the configuration of the sensing-configured grant. In another example, this information indicates the configuration of the sensing signal received and/or transmitted by the user terminal. This information has beneficial effects of: helping the first node to obtain the configuration required when receiving and/or transmitting a sensing signal, and further reducing the signaling overhead in the sensing trigger signaling. The content contained in this information may be made with reference to the above “first sensing signal related information”.
Second report indication information, which indicates information for the first node to report the sensing result. The specific description may be made with reference to the above “first report indication information”.
Configuration information associated with acquiring first configuration request message, which is used to configure how the first node obtains the sensing trigger signaling. After receiving this information, the first node may receive the signaling that triggers it to perform sensing based on the configuration of this information. In an example, the sensing trigger signaling may be the above “first configuration request message”. This information has beneficial effects that: the first node can only acquire the sensing trigger signaling within configured resources, and reduce the signaling overhead and energy consumption before performing the transmission and/or reception of a sensing signal. This information includes at least one of the following information:
   First signaling decoding information, which indicates the information that the first node needs to use when acquiring the sensing trigger signaling. In an example, this information is used when the first node demodulates information on the physical channel, such as sensing-RNTI. The first node needs to utilize this information to descramble the downlink control information carried on the physical channel, and in turn obtain the trigger signaling that triggers the first node to perform the reception and/or transmission of a sensing signal according to the downlink control information. This information has beneficial effects of: helping the first node to obtain the sensing trigger signaling, in turn starting the reception and/or transmission of a sensing signal, and reducing the signaling overhead and energy consumption;
   Related resource configuration information, which indicates a resource configuration for receiving the sensing trigger signaling. The configuration information can help the first node to obtain the sensing trigger signaling, and reduce the energy consumption before performing the reception and/or transmission of a sensing signal. This information includes at least one of the following information:
      Third time domain resource information, which indicates the configuration of the time domain of the sensing trigger signaling, that is, indicates in which time range the first node needs to perform the reception of sensing trigger signaling. This information has beneficial effects of reducing the energy consumption of the first node receiving the sensing trigger signaling. This information includes at least one of the following information:
         Periodic information, such as a periodicity, cycle;
         Reference time domain position indication information, such as reference time, a super-frame number, etc.;
         Offset information, such as an offset, a start offset, which indicates an offset relative to a reference position (which may be either the position indicated by the above “reference time domain position indication information”, or a implicitly indicated position) when the user is receiving the sensing trigger signaling, and may also indicates an offset within a time interval (such as a subframe, a frame, a time slot, etc.) (such as indicating which symbol, which time slot, which subframe etc. in the time interval).
         Time length information, which indicates a time length for receiving the sensing trigger signaling, such as in milliseconds, number of symbols, etc.
         In an example, the above “second time domain configuration information” may be the configuration information of discontinuous reception (DRX), which is used for performing the reception of sensing trigger signaling.
      Third frequency domain resource information, which indicates the configuration of resources on frequency domain for the sensing trigger signaling. This information includes at least one of the following information:
         Carrier frequency information, which indicates the carrier frequency where the sensing trigger signaling is located;
         Carrier interval information, which indicates the subcarrier spacing used for the sensing trigger signaling;
         Frequency domain range information, which indicates a range of frequency domain where the sensing trigger signaling is located. This information may include at least one of the following information:
         Identification information for a bandwidth range, such as bandwidth part ID;
         Position information of a starting point of a frequency domain range, such as frequency point information, serial number information of subcarriers, serial number information of resource blocks, serial number information of subcarriers, serial number information of subbands, etc.
         Position information of a ending point of a frequency domain range, such as frequency point information, serial number information of subcarriers, serial number information of resource blocks, serial number information of subcarriers, serial number information of subbands, etc.
         Size information of a frequency domain range, such as bandwidth information, information of number of subcarriers, information of number of resource blocks, etc.
      Third spatial domain resource information, which indicates the configuration of resources on spatial domain for the sensing trigger signaling. This information includes at least one of the following information:
         Beam indication information, such as beam identification, TCI (transmission configuration indicator). This information indicates the beam required for receiving the sensing trigger signaling;
         Associated beam indication information, which indicates a beam associated with the beam used to receive the sensing trigger signaling. In an example, this information may indicate a beam of an associated synchronization signal (such as SSB);
   Second configuration identification information, or second configuration index information, which is used to identify a group of a configuration related to sensing. The configuration may be at least one of the above “second state indication information”, “second node indication information”, “second sensing signal related information”, “second report indication information” and “configuration information associated with acquiring first configuration request message”.

The above “second state indication information” and/or “second report indication information” may be “state information related to sensing”.

The above “first configuration message” may be an RRC message, for example an RRC message used when releasing the first user to the non-connected state, such as an RRC Release message, or may be a system message.

The above “first configuration message” may be information related to sensing pre-configured for the first node, and the information contained in this information may be information of receiving the first configuration request message and/or information of the state related to sensing. The “information of the state related to sensing” may be at least one of the above “second state indication information”, “second sensing signal indication information”, “configuration information of second sensing signal” and “second report indication information”, and the above “information of receiving the first configuration request message” may be the above “configuration information associated with acquiring the first configuration request message”. It can be understood that the first configuration message in the present application may include one or more groups of configurations, and each group of configurations will contain the above “information of the state related to sensing” and/or “information of receiving the first configuration request message”, whereas the information contained in the first configuration request message is used for indicating one of the multiple groups of configurations.

In an example, the first node may directly perform the transfer of a sensing signal according to the configuration information in the first configuration request message, so the network side does not need to pre-configure for the first node (such as does not need the above steps 1-0a), and the method has beneficial effects of reducing the signaling overhead of pre-configuring the user terminal.

In another example, the first node may perform the transfer of a sensing signal according to the above first configuration message and first configuration request message. The above first configuration message is used to pre-configure to the first node the information for transferring sensing signals. This information may include multiple different groups of configurations, and each group of configurations contains at least one of the above “second state indication information”, “second sensing signal indication information”, “configuration information of second sensing signal”, “second report indication information”, and “configuration information associated with acquiring the first configuration request message”. Then, the first configuration request message is used for indicating the configuration required for the first node to perform the transfer of a sensing signal (this configuration is one of multiple different groups of configurations contained in the above first configuration message), and in turn the first node may determine the configuration for transferring sensing signals according to the information in the first configuration message. The method has beneficial effects of: reducing the signaling overhead of configuring the user terminal for performing the transfer of a sensing signal.

Transmitting the first configuration message to the first node by the third node (of course, it can also be another node, such as the second node, the fourth node, etc.) can help the user equipment in the non-connected state to obtain the first configuration request message and/or the configuration information of the reception and/or transmission of a sensing signal, and reduce the signaling overhead and energy consumption for the user before receiving and/or transmitting sensing signals. Furthermore, through the indication information of the second sensing signal included in the first configuration message, the first node is helped to determine whether it is required to perform the reception and/or transmission of a sensing signal. Furthermore, through the configuration information of the second sensing signal included in the first configuration message, the first node is helped to obtain the configuration required when receiving and/or transmitting sensing signals, in turn the signaling overhead in the sensing trigger signaling can also be reduced. Furthermore, through the second report indication information included in the first configuration message, the condition for the first node to perform the reporting of sensing result is determined, the unnecessary connection setup process is reduced, and the energy consumption and signaling overhead of the first node is further reduced. Moreover, the present disclosure also provides a variety of different implementations of the first configuration message, which makes the implementation of the first configuration message more flexible and can adapt to more scenarios.

Please continue to refer to FIG. 4, as an embodiment, after the first node receives the first configuration message, it may further comprise the following steps:

Step 1-0b: The first node receives the sensing trigger signaling, and in turn determines the configuration required for performing the transmission and/or reception of a sensing signal.

When the first node receives the sensing trigger signaling, there are several implementations as follows:
Implementation 1: The resources for scheduling the sensing trigger signaling are obtained through the physical channel.

In this way, the first node decodes information in a physical channel (such as physical downlink control channel (PDCCH)). In an example, the information on the physical channel may be scrambled by certain type of information (such as the downlink control information (DCI) scrambled by the above “first signaling decoding information”). The information contained in the physical channel includes the resources for receiving the sensing trigger signaling, and the first node may receive the sensing trigger signaling on the resources.
Implementation 2: The sensing trigger signaling is acquired through the paging message.

In this way, the first node receives the sensing trigger signaling via the way for receiving the paging message. For example, the first node utilizes P-RNTI (Paging-Radio Network Temporary Identifier) to decode the physical channel, and in turn obtains the resources for receiving paging messages from the physical channel.
Implementation 3: The sensing trigger signaling is acquired through the physical channel.

In this way, the first node acquires the sensing trigger signaling directly through the information on the physical channel, for example, the sensing trigger signaling is acquired through the downlink control information (DCI).

Embodiments of the present disclosure provide various and flexible ways for receiving the sensing trigger signaling (i.e., the first configuration request message), which makes the application modes of the present disclosure more diverse.

Optionally, after the first node receives the sensing trigger signaling (such as the above first configuration request message), the first node performs the reception and/ or transmission of a sensing signal. Please continue to refer to FIG. 4, and the above method may further comprise the following steps:

Step 1-2: The first node performs the reception and/or transmission of a sensing signal. Specifically, the first node will perform the reception and/or transmission of a sensing signal according to the received configuration information. After receiving the above “first configuration request message”, the first node determines its behavior of reception and/or transmission of a sensing signal. Possible behaviors include at least one of:
Behaviour 1: This behaviour is the behaviour of the first node when the above “first configuration request message” contains the “first user indication information”. If the received “first user indication information” matches the information at the first node (which may be configured to the first node before step 1-1, such as at step 1-0a, or may be allocated by the upper layer protocol of the first node), the first node needs to perform the reception and/or transmission of a sensing signal.
Behaviour 2: This behaviour is the behaviour of the first node when the above “first configuration request message” contains the “first sensing signal related information”. In an example, before step 1-1 (such as at step 1-0a), the first node may obtain (e.g., through a system message or through an RRC message) the configuration information (hereinafter referred to as “second sensing signal related information”) required for receiving and/or transmitting sensing signals from the second node or other nodes. After receiving the “first sensing signal related information” in the “first configuration request message”, the first node may determine the required received and/or transmitted sensing signal in conjunction with the “second sensing signal related information”. For example, in the following “second sensing signal related information”, the first node obtains the configuration information of the reception and/or transmission of one or more types of sensing signals, and the configuration for each type of the sensing signal contains at least one of the information indicated in the “first sensing signal related information”. The “first sensing signal related information” contained in the above “first configuration request message” will indicate the first node to perform the reception and/or transmission of one type of the sensing signals.
Behaviour 3: This behaviour is the behaviour of the first node when the above “first configuration request message” contains the “first report indication information”. In an example, after receiving the above “first configuration request message”, the first node starts the process of connection setup or resume only after the condition indicated by the “first report indication information” is met.
Behaviour 4: This behaviour is that after determining that it is required to perform the reception and/or transmission of a sensing signal, the first node performs the storage of the obtained sensing result, for example, this behaviour performs after behaviour 1 and behaviour 2. The sensing result stored by the first node includes at least one of the following information:
   Third sensing signal indication information, which indicates the sensing signal to which the sensing result is referring. This information at least includes one of the following information:
      Identification information for a third user, which indicates the user to which the sensing signal is referring, such as TMSI, I-RNTI, sensing ID, sensing-RNTI, etc.
      Identification information for a third user group, which indicates the user group to which the sensing signal is referring, such as UE group ID, sensing group ID, etc.
      Identification information for a third area, which indicates the area to which the sensing signal is referring, such as area ID, RAN ID, TA ID, sensing area ID, cell ID, cell group ID, etc.
      Identification information for a third service, which indicates the service to which the sensing signal is referring, such as sensing service ID, sensing application ID, etc.
      Configuration information of a third sensing signal, which indicates the configuration of the sensing signal. For details, please refer to the above “first sensing signal related information”.
   Third sensing result indication information, which indicates the sensing result obtained by the first node. This information includes at least one of the following information:
      A resolution of sensing;
      A measurement result of a sensing signal;
      An accuracy of a sensing signal;
      A number of times for transmitting sensing signals;
      A number of times for receiving sensing signals.

The above sensing results are merely examples, and all the sensing results that can be reported may be included in the above “sensing result indication information”. In an example, the sensing result may be stored as an information element (such as an information element in an RRC message). In another example, the sensing result may be stored as a container.

The embodiments of the present disclosure provide a variety of different implementations that the first node determines the reception and/or transmission of its sensing signal after receiving the above “first configuration request message”, and provide a variety of implementations of the stored sensing results, so that the contents that can be selected when reporting the stored sensing results are more diverse, and so that the implementations in which the first node determines the reception and/or transmission of its sensing signal based on the first configuration request message are more diverse, and can adapt to more scenarios.

Please continue to refer to FIG. 4, optionally, after the first node obtains the sensing results, it needs to report these sensing results to the network side. Therefore, the method may further comprise the following steps:

Step 1-3: When the first node determines that it is required to report the sensing result, the first node will start the process of the connection setup or resume, such as setting up or resuming a connection between the first node and the fourth node (or the second node, or the third node, or other nodes). When the first node determines whether it is required to report the sensing result, in an example, it may determine according to the reporting condition indicated by the above “first report indication information”, or in another example, it can determine according to the trigger of the upper layer, or in another example, it may report when the area where the first node is located changes (in order to obtain information of whether the area has changed, the first node may determine according to whether the identification information for the area to which the resident cell belongs has changed, and the identification information for the area may be area ID, RNA ID, TA ID, sensing area ID, cell ID, cell group ID, etc.). In addition, after starting the process of the connection setup or resume, the first node will transmit a request message for the connection setup or resume to the second node or other nodes (the second node or other nodes are the nodes to which the first node is connected when performing the reporting of sensing results). This information will indicate the cause information for connection setup or resume, such as sensing, reporting of sensing results, etc.

Please continue to refer to FIG. 4, optionally, reporting the sensing results by the first node further comprises the following steps:
Step 1-4: The first node transmits a first report message to a fourth node (such as a second node, a third node, or other nodes). This message is used to provide the sensing result obtained by the first node. This message includes at least one of the following information:
   Fourth sensing signal indication information, which indicates the sensing signal to which the sensing result is referring. This information at least includes one of the following information:
      Identification information for a fourth user, which indicates the user to which the sensing signal is referring, such as TMSI, I-RNTI, sensing ID, sensing-RNTI, etc.
      Identification information for a fourth user group, which indicates the user group to which the sensing signal is referring, such as UE group ID, sensing group ID, etc.
      Identification information for a fourth area, which indicates the area to which the sensing signal is referring, such as area ID, RAN ID, TA ID, sensing area ID, cell ID, cell group ID, etc.
      Identification information for a fourth service, which indicates the service to which the sensing signal is referring, such as sensing service ID, sensing application ID, etc.
      Configuration information of a fourth sensing signal, which indicates the configuration of the sensing signal. For details, please refer to the above “first sensing signal related information”.
   Fourth sensing result indication information, which indicates the sensing result obtained by the first node, and at least includes one of the following information:
      A resolution of sensing;
      A measurement result of a sensing signal;
      An accuracy of a sensing signal;
      A number of times for transmitting sensing signals;
      A number of times for receiving sensing signals.

The above sensing results are merely examples, and all the sensing results that can be reported may be included in the above “sensing result indication information”.

In an example, the sensing result may be reported as an information element (such as an information element in an RRC message). In another example, the sensing result may be reported as a container (i.e., the sensing result is contained in the container). The above “first report message” may be an RRC message, such as a UEInformationResponse message, a UEAssistantInformation message, or a new message.

Through the above mechanism, the first node is made to establish a connection or reconnect with the network node only when it meets the condition for reporting the sensing result, so as to perform the reporting, which reduces the unnecessary connection setup process, thereby reducing the energy consumption and signaling overhead of the first node.

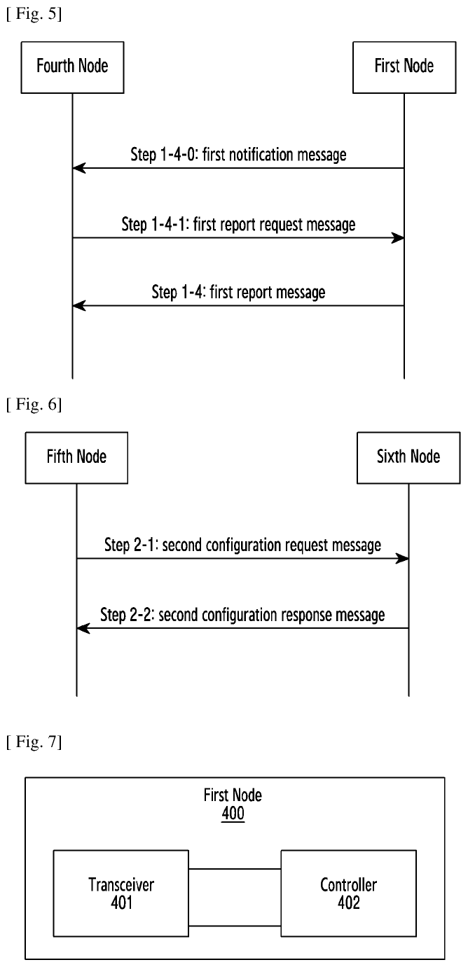

Please refer to FIG. 5, which is a schematic diagram of a first node interacting with a fourth node according to an embodiment of the present disclosure.

As an implementation, the reporting of the sensing result may also be based on the request of the network side, that is, the first node reports only when the network side requests the report. Therefore, optionally, before steps 1-4, the method may further comprise, as shown in FIG. 5:

Step 1-4-1: The fourth node transmits a first report request message to the first node, and this message is used to request the first node to report the sensing result. This message includes at least one of the following information:
First sensing result request indication information, which indicates the first node to report its stored sensing result.
First sensing result report indication information, which indicates the information of the sensing signal to which the sensing result that the first node is requested to report is referring. This information includes at least one of the following information:
   First position request information, which indicates the position of the reception and/or transmission of a sensing signal for which the sensing result requested to be reported is referring. This information may be area ID, cell ID, cell group ID, RNA ID, TA ID, sensing area ID, etc. The first node only reports the sensing results obtained within the position indicated by this information.
   First service request information, which indicates the sensing service to which the sensing result requested to be reported belongs, such as sensing service ID, sensing application ID, etc.
   First user request information, which indicates the user to which the sensing result requested to be reported belongs, such as identification information for a user, group identification information for a user, etc.
   First configuration request information, which indicates the configuration of the sensing signal corresponding to the sensing result requested to be reported. The description of the configuration indicated by this information may be made with reference to the above “first sensing signal related information”.

The above “first report request message” may be an RRC message, such as a UEInformationRequest message, or a new message.

The first report request message is transmitted to the first node through the fourth node, and this message is used to request the first node to report the sensing results.

The first node will determine the reported sensing results according to the requirements of the network side, without reporting all the sensing results, thus reducing the signaling overhead of the first node and saving energy consumption.

Please continue to refer to FIG. 5, further, in order for the network side to learn whether a sensing result is stored at the first node, optionally, before step 1-4-1, the method further comprises:

Step 1-4-0: The first node transmits a first notification message to the fourth node, and this message is used to notify the network side of the sensing result obtained at the first node. The first notification message includes at least one of the following information:
First sensing result storage indication information, which indicates whether the first node stores the sensing result, such as a sensing result availability.
Position information of a first sensing result, which indicates the position of the reception and/or transmission of the sensing signal corresponding to the sensing result stored by the first node, such as area ID, cell ID, cell group ID, RNA ID, TA ID, sensing area ID, etc. After receiving this information, the second node or another node can determine the sensing results corresponding to which positions it needs the first node to report.
Service information of a first sensing result, which indicates the sensing service corresponding to the sensing result stored by the first node, such as sensing service ID, sensing application ID, etc. After receiving this information, the second node or another node can determine that it need the first node to report the sensing result corresponding to the service.
User information of a first sensing result, which indicates the user corresponding to the sensing result stored by the first node, such as identification information for a user, identification information for a user group, etc. After receiving this information, the second node or another node can determine that it needs the first node to report the sensing result corresponding to the user or user group.
Configuration information of a first sensing result, which indicates the configuration corresponding to the sensing result stored by the first node. The description of the configuration indicated by this information may be made with reference to the above “first sensing signal related information”.

The first notification message is transmitted to the fourth node through the first node, so as to inform the network side of the sensing results stored in the user terminal, thus facilitating the network side to acquire these sensing results and making it possible to timely complete the sensing task according to the sensing results.

Please refer to FIG. 6, which is a schematic diagram of a fifth node interacting with a sixth node according to an embodiment of the present disclosure.

According to different sensing modes, in addition that the user terminal needs to perform the reception and/or transmission of a sensing signal, the base station may also need to perform the reception and/or transmission of a sensing signal. When the base station contains a centralized unit and a distributed unit, the distributed unit of the base station also needs to perform configuration of the reception and transmission of a sensing signal. Moreover, when the sensing trigger signaling is transmitted to the user terminal, if this signaling is not an RRC message (such as physical layer signaling, MAC layer signaling, etc.), the distributed unit of the base station also needs to perform the transmission of the sensing trigger signaling. In order to realize the resource configuration for the sensing signal and the transmission of the sensing trigger signal, the present invention also includes the interaction between the centralized unit of the base station and the distributed unit of the base station, as shown in FIG. 6:

Step 2-1: The centralized unit of the base station (the fifth node) transmits a second configuration request message to the distributed unit of the base station (the sixth node) (it can be understood that the message name is not a limitation to the present application, for example, the second configuration request message may also be referred to as the third message, etc., and any message that achieves the same effect or contains the same content belongs to the scope of the present invention, and the following message types will not be detailed). This message is used to: 1) configure the resources for sensing signals, and/or, 2) transmit the sensing trigger signaling, and/or, 3) receive and/or transmit the sensing trigger signaling. The above second configuration request message includes at least one of the following information:
The first resource request information, which is used to request the distributed unit of the base station to perform the configuration of sensing resources. This information has beneficial effects of: helping the distributed unit of the base station to perform the resource allocation of a sensing signal, and improving the utilization efficiency of resources. This information includes at least one of the following information:
   Identification information for a third sensing signal, which indicates a type of a sensing signal. For different sensing signals, there may be different resource allocations. This information may be used for indicating different types of a sensing signal.
   Sensing performance indication information, which is used for indicating the sensing performance required to be met for the reception and/or transmission of a sensing signal. In an example, this information may also be the QoS requirement of sensing services. In an example, the distributed unit of the base station may utilize this information to allocate resources for the reception and transmission of a sensing signal. This information has beneficial effects of: helping the distributed unit of the base station to allocate resources, so as to guarantee the performance required for the sensing services. This information includes one of the following information:
      An accuracy of sensing;
      A resolution of sensing;
      A Quality of service (QOS) of detection, such as an accuracy of detecting objects;
      A QoS of positioning, such as an accuracy of delay estimation and an accuracy of an Angle of arrival;
      A QoS of tracking, such as an accuracy of a range, an accuracy of an angle and an accuracy of a velocity.
   Identification information for a third user, which may be made with reference to the above “identification information for first user”;
   Identification information for a third user group, which may be made with reference to the above “identification information for first user group”;
   Identification information for a third area, which may be made with reference to the above “identification information for first area”;
   Identification information for a third service, which may be made with reference to the above “identification information for first service”;
   Third sensing signal resource request information, which indicates the resources required for the reception and/or transmission of a sensing signal. After receiving this information, the distributed unit of the base station may determine whether the request for resource may be met according to its own resource situation. This information includes at least one of the following information:
      Third configuration identification information, which identifies the requested resources. The base station may utilize this information to indicate whether it can meet the requested resources;
      Third valid time indication information, which indicates the valid time of the requested resource. The detailed description may be made with reference to the above “first valid time indication information”;
      Third sensing type indication information, which indicates the type of the sensing signal served by the requested resource. The detailed description may be made with reference to the above “sensing type indication information”;
      Third receiving and transmitting indication information, which indicates the receiving and transmitting mode of the sensing signal served by the distributed unit of the base station. The detailed description may be made with reference to the above “receiving and transmitting indication information”;
      Third resource indication information, which indicates the requested resource. The detailed description may be made with reference to the above “configuration information of a sensing signal”.
First trigger signaling information, which may contain the sensing trigger signaling transmitted to the user terminal, and its main purpose is to trigger the user terminal to start the reception and/or transmission of a sensing signal. The information contained in this information may be made with reference to the above “first configuration request message”. This information has beneficial effects of: triggering the user terminal to perform the reception and/or transmission of a sensing signal, ensuring that the user terminal can receive and/or transmit the sensing signal on proper resources, and ensuring the performance of the sensing service. On the other hand, if the sensing signal received by the user terminal comes from the sixth node, this information may also trigger the sixth node to transmit the sensing signal, or if the sensing signal transmitted by the user terminal needs to be received by the sixth node, this information may also trigger the sixth node to receive the sensing signal. Therefore, another beneficial effect of this information is to trigger the sixth node to perform the transmission and/or reception of a sensing signal, and to ensure that the sixth node transmits the sensing signal on the resource where the user terminal receives the sensing signal, or receives the sensing signal on the resource where the user terminal transmits the sensing signal, that is, to ensure the sensing of proper reception of signal by the user terminal or proper reception of a sensing signal of the user terminal.
Second trigger signaling information, which is used to trigger the sixth node to perform the reception and/or transmission of a sensing signal. After receiving this information, the sixth node needs to determine the transmitted sensing signal and/or the received sensing signal according to the content in this information. The content of this information may be made with reference to the above “first configuration request message”. This information has beneficial effects of: triggering the sixth node to perform the reception and/or transmission of a sensing signal, ensuring that the user equipment can properly perform the reception of a sensing signal, while ensuring that the sixth node can properly receive the sensing signal transmitted by the user equipment.

Optionally, please continue to refer to FIG. 6. This method may further comprise step 2-2 to indicate the result of resource allocation to the sixth node.

Step 2-2: The sixth node transmits a second configuration response message to the fifth node (it can be understood that the message name is a limitation to the present application, for example, the second configuration response message may also be referred to as a fourth message, and any message that achieves the same function or contains the same content belongs to the scope of the present invention, and the following message types will not be detailed), and this message is used to indicate the result of resource allocation for receiving and/or transmitting sensing signals. This message has beneficial effects of: determining the resources of the sensing signals that the sixth node can receive and/or transmit, while helping the fifth node to determine the sensing signals that can be received and/or transmitted. When the sixth node cannot transmit and/or transmit some sensing signals, the sixth node can negotiate with other nodes to guarantee the reception and/or transmission of a sensing signal. The above second configuration request message includes at least one of the following information:
Acceptance indication information, which indicates the sensing signal that the sixth node can accept. Further, if the sixth node accepts to serve the sensing signal, it means that the sixth node has allocated resources for the sensing signal. In order to indicate these accepted sensing signals, this information may be indicated by at least one of the following information:
   Identification information for a fourth sensing signal;
   Identification information for a fourth user;
   Identification information for a fourth user group;
   Identification information for a fourth area;
   Identification information for a fourth service;
   Identification information for a fourth configuration, which indicates resources for sensing signals.
   Any one of the above information is used for indicating a type of a sensing signal, and different information indicates different sensing signals.
Rejection indication information, which indicates the sensing signal rejected by the sixth node. Further, if the sixth node refuses to serve the sensing signal, it means that the sixth node refuses to allocate resources for the sensing signal. In order to indicate these rejected sensing signals, this information may be indicated by at least one of the following information:
   Identification information for a fifth sensing signal;
   Identification information for a fifth user;
   Identification information for a fifth user group;
   Identification information for a fifth area;
   Identification information for a fifth service;
   Identification information for a fifth configuration, which indicates resources for sensing signals.
   Any one of the above information is used for indicating a type of a sensing signal, and different information indicates different sensing signals.

The above second configuration request message may be a paging message of the F1 interface, a gNB-CU configuration update message, or a newly defined message, such as a sensing trigger request message, a sensing resource allocation request message, etc. The above second configuration response message may be a F1 interface gNB-CU configuration update acknowledge message, or a newly defined message, such as a sensing trigger response message, a sensing resource allocation response message, etc.

By means of the above methods, the serving for allocating resources for the reception and/or transmission of a sensing signal is realized, and the distributed unit of the user terminal/base station is ensured to perform the reception and/or transmission of a sensing signal.

In addition, it can be understood that the contents contained in each message in the above embodiments are merely examples of this disclosure, and the contents contained in various similar or identical messages may be replaced with each other, or named with different names, or some items can be added or deleted, depending on the situation. And for brevity, the meanings among similar content items can be mutually explained according to the context without further details. The modified and explained implements still belong to the scope of protection of the present invention.

FIG. 7 is a block diagram showing a structure of a first node 400 according to an embodiment of the present disclosure.

Referring to FIG. 7, the first node 400 includes a transceiver 401 and a controller 402. The transceiver 401 is configured to transmit and/or receive signals to and from the outside. The controller 402 may include at least one processor and is configured to perform the above-described method performed by the first user equipment. The first user equipment 400 may be implemented in the form of hardware, software, or a combination of hardware and software, so as to enable it to perform the method performed by the first node described in the present disclosure.

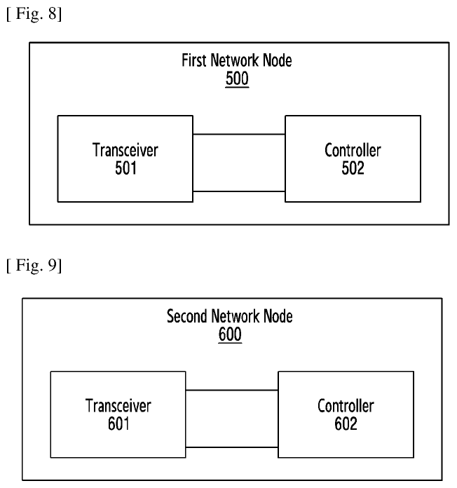

FIG. 8 is a block diagram showing a structure of a first network node 500 according to an embodiment of the present disclosure.

Referring to FIG. 8, a first network node 500 includes a transceiver 501 and a controller 502. The transceiver 501 is configured to transmit and/or receive signals to and from the outside. The controller 502 may include at least one processor and is configured to perform a method performed by a first network node. The first network node 500 may be implemented in the form of hardware, software, or a combination of hardware and software, so as to enable it to perform the method performed by the first network node described in the present disclosure.

FIG. 9 is a block diagram showing a structure of a second network node 600 according to an embodiment of the present disclosure.

Referring to FIG. 9, the second network node 600 includes a transceiver 601 and a controller 602. The transceiver 601 is configured to transmit and/or receive signals to and from the outside. The controller 602 may include at least one processor and is configured to perform a method performed by a second network node. The second network node 600 may be implemented in the form of hardware, software, or a combination of hardware and software, so as to enable it to perform the method performed by the second network node described in the present disclosure.

At least one embodiment of the present disclosure also provides a non-transitory computer-readable recording medium having stored a program thereon, which when executed by a computer, performs the above-described method.

Various embodiments of the present disclosure may be implemented as computer-readable codes embodied on a computer-readable recording medium from a specific perspective. A computer-readable recording medium is any data storage device that can store data readable by a computer system. Examples of computer-readable recording media may include read-only memory (ROM), random access memory (RAM), compact disk read-only memory (CD-ROM), magnetic tape, floppy disk, optical data storage device, carrier wave (e.g., data transfer via the Internet), etc. Computer-readable recording media can be distributed by computer systems connected via a network, and thus computer-readable codes can be stored and executed in a distributed manner. Furthermore, functional programs, codes and code segments for implementing various embodiments of the present disclosure can be easily explained by those skilled in the art to which the embodiments of the present disclosure are applied.

It will be understood that the embodiments of the present disclosure may be implemented in the form of hardware, software, or a combination of hardware and software. The software may be stored as program instructions or computer-readable codes executable on a controller on a non-transitory computer-readable medium. Examples of non-transitory computer-readable recording media include magnetic storage media (such as ROM, floppy disk, hard disk, etc.) and optical recording media (such as CD-ROM, digital video disk (DVD), etc.). Non-transitory computer-readable recording media may also be distributed on computer systems coupled to a network, so that computer-readable codes are stored and executed in a distributed manner. The medium can be read by a computer, stored in a memory, and executed by a controller. Various embodiments may be implemented by a computer or a portable terminal including a controller and a memory, and the memory may be an example of a non-transitory computer-readable recording medium suitable for storing program(s) with instructions for implementing embodiments of the present disclosure. The present disclosure may be realized by a program with code for concretely implementing the apparatus and method described in the claims, which is stored in a machine (or computer)-readable storage medium. The program may be electronically carried on any medium, such as a communication signal transmitted via a wired or wireless connection, and the present disclosure suitably includes its equivalents.

What has been described above is only the specific implementation of the present disclosure, but the scope of protection of the present disclosure is not limited thereto. Anyone who is familiar with this technical field may make various changes or substitutions within the technical scope disclosed in the present disclosure, and these changes or substitutions should be covered within the scope of protection of the present disclosure. Therefore, the scope of protection of the present disclosure should be based on the scope of protection of the claims.

1. A method performed by a terminal in a wireless communication system, the method comprising:
receiving, from a base station, a first message triggering a sensing for a group of terminals including the terminal in a radio resource control (RRC) idle state or an RRC inactive state, wherein the first message includes information for indicating the group of terminals; and
identifying to start the sensing based on the first message.

2. The method of claim 1, wherein the information comprises at least one of a geographic area identifier, a service identifier, a group identifier, or a sensing signal identifier associated with the sensing.

3. The method of claim 1, further comprising:
receiving, before the receiving of the first message, a second message including at least one of decoding information and resource configuration information for the sensing,
wherein the decoding information is for decoding downlink control information for the first message, and
wherein the resource configuration information is for identifying at least one of a time resource, a frequency resource, or a spatial resource for the first message.

4. The method of claim 1, further comprising:
transmitting, to the base station, a third message for a connection setup or a connection resume, in case that a configured condition is satisfied after the receiving of the first message.

5. A method performed by a base station in a wireless communication system, the method comprising:
identifying a group of terminals including a terminal; and
transmitting, to the terminal, a first message triggering a sensing for the group of terminals including the terminal in a radio resource control (RRC) idle state or an RRC inactive state, wherein the first message includes information for indicating the group of terminals.

6. The method of claim 5, wherein the information comprises at least one of a geographic area identifier, a service identifier, a group identifier, or a sensing signal identifier associated with the sensing, and
wherein the method further comprises receiving, from the terminal, a third message for a connection setup or a connection resume, in case that a configured condition is satisfied after the receiving of the first message.

7. The method of claim 5, wherein the method further comprises:
transmitting, before the transmitting of the first message, a second message including at least one of decoding information and resource configuration information for the sensing,
wherein the decoding information is for decoding downlink control information for the first message, and
wherein the resource configuration information is for at least one of a time resource, a frequency resource, or a spatial resource for the first message.

8. A terminal in a wireless communication system, the terminal comprising:
a transceiver; and
a controller coupled with the transceiver and configured to:
receive, from a base station, a first message triggering a sensing for a group of terminals including the terminal in a radio resource control (RRC) idle state or an RRC inactive state, wherein the first message includes information for indicating the group of terminals, and
identify to start the sensing based on the first message.

9. The terminal of claim 8, wherein the information comprises at least one of a geographic area identifier, a service identifier, a group identifier, or a sensing signal identifier associated with the sensing.

10. The terminal of claim 8, wherein the controller is further configured to:
receive, before the receiving of the first message, a second message including at least one of decoding information and resource configuration information for the sensing,
wherein the decoding information is for decoding downlink control information for the first message, and
wherein the resource configuration information is for identifying at least one of a time resource, a frequency resource, or a spatial resource for the first message.

11. The terminal of claim 8, wherein the controller is further configured to:
transmit, to the base station, a third message for a connection setup or a connection resume, in case that a configured condition is satisfied after the receiving of the first message.

12. A base station in a wireless communication system, the base station comprising:
a transceiver; and
a controller coupled with the transceiver and configured to:
identify a group of terminals including a terminal, and
transmit, to the terminal, a first message triggering a sensing for the group of terminals including the terminal in a radio resource control (RRC) idle state or an RRC inactive state, wherein the first message includes information for indicating the group of terminals.

13. The base station of claim 12, wherein the information comprises at least one of a geographic area identifier, a service identifier, a group identifier, or a sensing signal identifier associated with the sensing.

14. The base station of claim 12, wherein the controller is further configured to:
transmit, before the transmitting of the first message, a second message including at least one of decoding information and resource configuration information for the sensing,
wherein the decoding information is for decoding downlink control information for the first message, and
wherein the resource configuration information is for at least one of a time resource, a frequency resource, or a spatial resource for the first message.

15. The base station of claim 12, wherein the controller is further configured to receive, from the terminal, a third message for a connection setup or a connection resume, in case that a configured condition is satisfied after the receiving of the first message.
